(19) United States
(12) Patent Application Publication
(10) Pub. No.: US 2014/0236750 A1
(43) Pub. Date: Aug. 21, 2014

(54) METHOD AND SYSTEM FOR SELLING PRODUCTS AND SERVICES VIA CROWDSOURCING AND REALITY TV SHOW

(71) Applicants: Tiger TG ZHOU, Tiburon, CA (US); Dylan TX ZHOU, San Gabriel, CA (US); Andrew HB ZHOU, Tiburon, CA (US)

(72) Inventors: Tiger TG ZHOU, Tiburon, CA (US); Dylan TX ZHOU, San Gabriel, CA (US); Andrew HB ZHOU, Tiburon, CA (US)

(21) Appl. No.: 14/260,650

(22) Filed: Apr. 24, 2014

Related U.S. Application Data
(63) Continuation of application No. 14/070,504, filed on Nov. 2, 2013.
Application No. 14/070,504 is a continuation-in-part of application No. 13/875,311, filed on May 2, 2013.
Application No. 13/875,311 is a continuation-in-part of application No. 13/620,775, filed on Sep. 15, 2012.
Application No. 13/620,775 is a continuation-in-part of application No. 13/185,491, filed on Jul. 18, 2011.
Application No. 14/070,504 is a continuation-in-part of application No. 13/868,405, filed on Apr. 23, 2013.
Application No. 13/868,405 is a continuation-in-part of application No. 13/287,279, filed on Nov. 2, 2011.
Application No. 14/070,504 is a continuation-in-part of application No. 13/471,773, filed on May 15, 2012.
Application No. 13/471,773 is a continuation-in-part of application No. 13/172,892, filed on Jun. 30, 2011, now abandoned.

(51) Int. Cl. G06Q 30/06

(52) U.S. Cl. CPC G06Q 30/0605
USPC 705/26.2

(57) ABSTRACT

Provided are computer implemented methods and systems for selling products and services using crowdsourcing. An exemplary method comprises receiving information associated with a crowdsourcing item. The crowdsourcing item is associated with an owner of the crowdsourcing item. The information includes a target amount for crowdsourcing. One or more contributions associated with the crowdsourcing item are received from one or more users. The total amount of the contributions is periodically calculated. When determined that the total amount has reached the target amount, the total amount is transferred to the owner. Additionally, the crowdsourcing item may be produced by the owner using the contributions and delivered to the users who made contributions either by one item to each of the users or by a share of the crowdsourcing item proportional to the contribution made.

### CROSS-REFERENCE TO RELATED APPLICATIONS

This application is a continuation of U.S. patent application Ser. No. 14/070,504, entitled “METHOD AND SYSTEM FOR SELLING PRODUCTS AND SERVICES VIA CROWDSOURCING AND REALITY TV SHOW” which is a continuation-in-part of U.S. patent application Ser. No. 13/287,279, entitled “METHODS AND SYSTEMS TO ADVERTISE AND SELL PRODUCTS OR SERVICES VIA CLOUD GAMING ENVIRONMENTS,” filed on Nov. 2, 2011, U.S. patent application Ser. No. 13/868,405, entitled “SYSTEM AND METHOD FOR ADVERTISING AND SELLING OF A VENTURE PROJECT VIA COMPETITIVE CAPITAL RAISING,” filed on Apr. 23, 2013, U.S. patent application Ser. No. 13/875,311, entitled “FACILITATING MOBILE DEVICE PAYMENTS USING MOBILE PAYMENT ACCOUNT, MOBILE BARCODE AND UNIVERSAL DIGITAL MOBILE CURRENCY,” filed on May 2, 2013, U.S. patent application Ser. No. 13/620,775, entitled “METHODS AND SYSTEMS FOR FACILITATING MOBILE DEVICE PAYMENTS USING CODES AND CASHBACK BUSINESS MODEL,” filed on Sep. 15, 2012, U.S. patent application Ser. No. 13/185,491, entitled “FACILITATING MOBILE DEVICE PAYMENTS USING PRODUCT CODE SCANNING,” filed on Jul. 18, 2011, U.S. patent application Ser. No. 13/471,773, entitled “RETAIL ENVIRONMENTS WITHIN SOCIAL NETWORKING ENGINES,” filed on May 15, 2012, U.S. patent application Ser. No. 13/172,892, entitled “RETAIL ENVIRONMENTS WITHIN SOCIAL NETWORKING ENGINES,” filed on Jun. 30, 2011, which are incorporated herein by reference in its entirety.

### FIELD

This application relates generally to data processing, and more specifically to methods and systems for selling products and services via crowdsourcing.

### BACKGROUND

The expansion of the Internet gave rise to a new community—online community, whose members are related to each other and accessible via a network. The size and accessibility of the online community creates vast opportunities for development of various online crowdsourcing models. Crowdsourcing is related to obtaining services, products, or ideas, by soliciting contributions from a large group of people. The crowdsourcing schemes may be employed for product development at all steps of product development lifecycle, from fund raising to sale of finished products or services by groups of people.

### SUMMARY

This summary is provided to introduce a selection of concepts in a simplified form that are further described below in the Detailed Description. This summary is not intended to identify key features or essential features of the claimed subject matter, nor is it intended to be used as an aid in determining the scope of the claimed subject matter.

Provided are computer implemented methods and systems for crowdsourcing. Using the methods or systems described herein an individual or organization may offer a task, product, poll, or project for crowdsourcing. For this purpose, the individual or organization may provide information on a crowdsourcing item to a crowdsourcing system. The crowdsourcing system may distribute the information and receive feedback and/or contributions from the users willing to take part in crowdsourcing to the crowdsourcing item. Depending on a type of the crowdsourcing item, the contributions may include investments, votes, content amendments, idea proposals, and so forth.

In various embodiments, the owner may specify a target of the crowdsourcing. For example, the target may include a target amount of investments. Alternatively, the target may include duration of the poll when votes of the users are received. When the target is reached, the crowdsourcing process may be completed, and the crowdsourcing system may transfer the contributions received from the users to the owner of the crowdsourcing item. The users, in consideration of the contributions, may be delivered a product associated with the crowdsourcing item, an acknowledgment, and/or award, and so forth.

In some embodiments, the crowdsourcing system may deduct or charge, to the owner, a fee for servicing the crowdsourcing item.

To the accomplishment of the foregoing and related ends, the one or more aspects comprise the features hereinafter fully described and particularly pointed out in the claims. The following description and the drawings set forth in detail certain illustrative features of the one or more aspects. These features are indicative, however, of but a few of the various ways in which the principles of various aspects may be employed, and this description is intended to include all such aspects and their equivalents.

### BRIEF DESCRIPTION OF DRAWINGS

Embodiments are illustrated by way of example and not limitation in the figures of the accompanying drawings, in which like references indicate similar elements and in which:

FIG. 1 is a block diagram showing an environment within which a method and system for selling products and services via crowdsourcing can be implemented, in accordance with an example embodiment.

FIG. 2 is a block diagram showing various modules of the crowdsourcing system, in accordance with certain embodiments.

FIG. 3 is a flow chart illustrating a method for selling products and services via crowdsourcing, in accordance with certain embodiments.

FIG. 4 is a flow chart illustrating an example representation of a product selling process via crowdsourcing, in accordance with certain embodiments.

FIG. 5 is a block diagram illustrating an example representation of a real show crowdsourcing, in accordance with certain embodiments.

FIG. 6 is a block diagram illustrating an example representation of a real show crowdsourcing via social networks, in accordance with certain embodiments.

FIG. 7 shows a diagrammatic representation of a computing device for a machine in the exemplary electronic form of a computer system, within which a set of instructions for causing the machine to perform any one or more of the methodologies discussed herein, can be executed.

### DETAILED DESCRIPTION

Various computer implemented methods and systems for selling products and services via crowdsourcing are described herein. Expansion of computer networks (Internet) gave rise to a new type of community—online community. Characteristic features of the online community include its large size and accessibility. Due to such features, the online community may be used as an audience for crowdsourcing models.

Crowdsourcing is based on performing a task by a crowd of people, for example, from the online community. The task may range from getting funding to selling a product or generating content (like in case with Wikipedia). Crowdsourcing may allows decreasing prices for some types of work, increasing quality and available options, implementing innovative ideas, generating content using “crowd wisdom”, and, in general, change the image of labor intake.

Open crowdsourcing systems may enable individuals or small businesses to crowdsource tasks, raise funds for new products or services, sell products to groups of people, receive public opinion by crowd-voting, involve crowd in idea-generating process, and so forth. A crowdsourcing system may provide means for those who seek crowdsourcing to place a crowdsourcing request and receive contributions from a crowd.

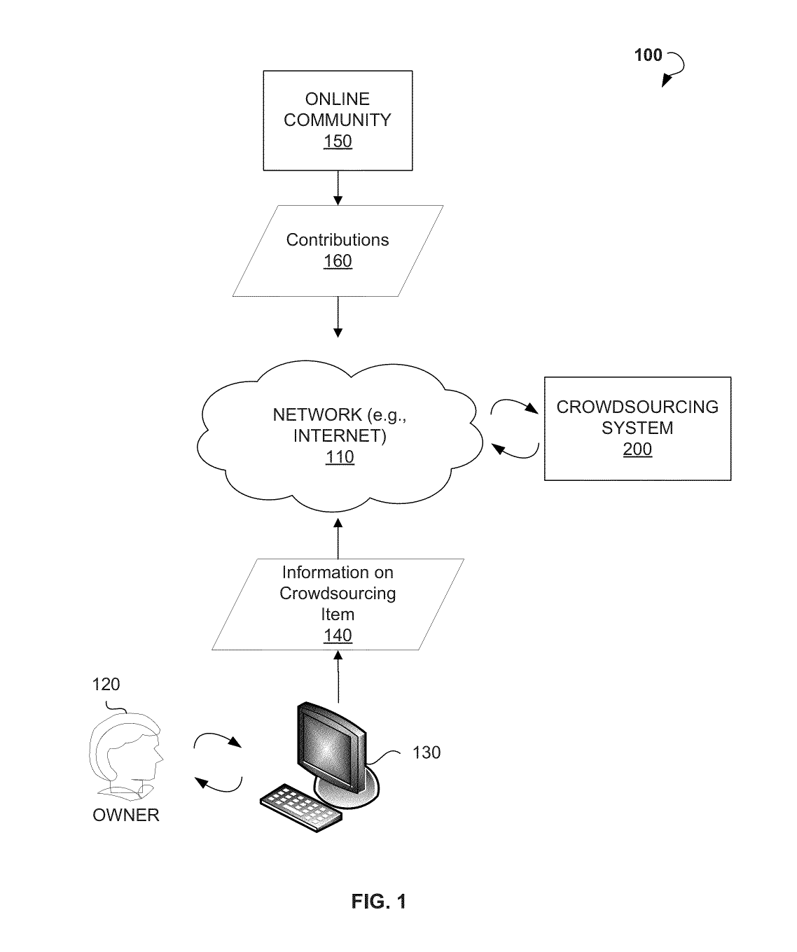

Referring now to the drawings, FIG. 1 illustrates an environment 100 within which a crowdsourcing system 200 and methods for crowdsourcing can be implemented. The environment 100 may include an owner 120, a client device 130, network 110, the crowdsourcing system 200, and online community 150.

The owner may include an individual, organization, or entity associated with a crowdsourcing item. The owner may provide information on crowdsourcing item 140 to the crowdsourcing system 200. The information on crowdsourcing item 140 may include textual, multimedia, or other information related to a crowdsourcing task for which the owner 120 desires to request contribution from the online community 150. In some embodiments, the information 140 may specify a target amount for contributions 160 to be received from the online community 150. This may be applicable to crowdsourcing items related to fund raising, business or innovation investing, and so forth. In other embodiments, for example, for crowd voting, the target amount may be not specified.

The crowdsourcing item may be associated with various types of contribution, including fund raising, collective purchase, crowd voting, crowd cloud gaming, crowd equity, and so forth.

The owner 120 may communicate with the crowdsourcing system 200 via the network 110 using the client device 130.

The network 110 may include the Internet or any other network capable of communicating data between devices. Suitable networks may include or interface with any one or more of, for instance, a local intranet, a PAN (Personal Area Network), a LAN (Local Area Network), a WAN (Wide Area Network), a MAN (Metropolitan Area Network), a virtual private network (VPN), a storage area network (SAN), a frame relay connection, an Advanced Intelligent Network (AIN) connection, a synchronous optical network (SONET) connection, a digital T1, T3, E1 or E3 line, Digital Data Service (DDS) connection, DSL (Digital Subscriber Line) connection, an Ethernet connection, an ISDN (Integrated Services Digital Network) line, a dial-up port such as a V.90, V.34 or V.34bis analog modem connection, a cable modem, an ATM (Asynchronous Transfer Mode) connection, or an FDDI (Fiber Distributed Data Interface) or CDDI (Copper Distributed Data Interface) connection. Furthermore, communications may also include links to any of a variety of wireless networks, including WAP (Wireless Application Protocol), GPRS (General Packet Radio Service), GSM (Global System for Mobile Communication), CDMA (Code Division Multiple Access) or TDMA (Time Division Multiple Access), cellular phone networks, GPS (Global Positioning System), CDPD (cellular digital packet data), RIM (Research in Motion, Limited) duplex paging network, Bluetooth radio, or an IEEE 802.11-based radio frequency network. The network 110 can further include or interface with any one or more of an RS-232 serial connection, an IEEE-1394 (Firewire) connection, a Fiber Channel connection, an IrDA (infrared) port, a SCSI (Small Computer Systems Interface) connection, a Universal Serial Bus (USB) connection or other wired or wireless, digital or analog interface or connection, mesh or Digi® networking. The network 110 may include any suitable number and type of devices (e.g., routers and switches) for forwarding commands, content, and/or web object requests from each client to the online community application and responses back to the clients. The device 200 may be compatible with one or more of the following network standards: GSM, CDMA, LTE, IMS, Universal Mobile Telecommunication System (UMTS), RFID, 4G, 5G, 6G and higher.

The client device 130, in some example embodiments, may include a Graphical User Interface (GUI) for displaying the user interface associated with the crowdsourcing system 200. In a typical GUI, instead of offering only text menus or requiring typed commands, the crowdsourcing system 200 may present graphical icons, visual indicators, or special graphical elements called widgets that may be utilized to allow the owner 120 to interact with the crowdsourcing system 200 and/or the online community 150. The client device 130 may be configured to utilize icons used in conjunction with text, labels, or text navigation to fully represent the information and actions available to owner 120 and/or online community 150.

The client device 130 may include a mobile telephone, a computer, a lap top, a smart phone, a tablet PC, and so forth. The information on crowdsourcing item 140 provided by the owner 120 via the client device 130 may be stored and, in certain embodiments, analyzed by the crowdsourcing system 200 so that online community 150 could retrieve and access the information on crowdsourcing item 140.

The online community 150 may include any and all users of the network 110. One or more users of the online community 150 may provide the contributions 160 to the crowdsourcing item. The contributions 160 may include monetary contributions, investments, content amendments, idea proposals, votes on a specific matter, and so forth.

In some cases, the crowdsourcing system 200 may process the received contributions 160, for example, to calculate their number or amount. Thus, when the crowdsourcing item is purchased or financed by the online community 150, the crowdsourcing system 200 may determine that the target amount for the purchase of financing is reached and transfer the contributions 160 to the owner 120.

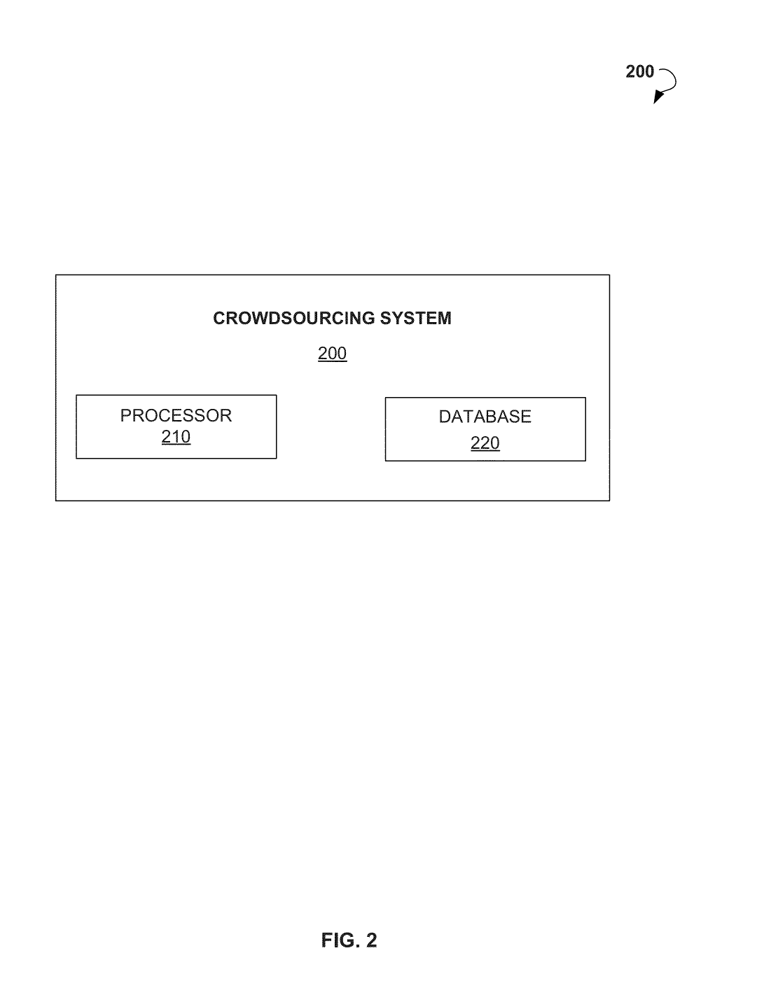

FIG. 2 is a block diagram showing various modules of the crowdsourcing system 200, in accordance with certain embodiments. The system 200 may comprise a processor 210 and a database 220. The processor 210 may include a programmable processor, such as a microcontroller, central processing unit (CPU), and so forth. In other embodiments, the processor 210 may include an application-specific integrated circuit (ASIC) or programmable logic array (PLA), such as a field programmable gate array (FPGA), designed to implement the functions performed by the system 200. Thus, the processor 210 may receive information on a crowdsourcing item from an owner of that item. The owner may specify the type of the crowdsourcing requested for the item, desired contributions, possible awards for contribution, and so forth.

In some embodiments, the crowdsourcing item may includes a crowdsourcing idea, where contributions may include sharing, commenting, improving, or otherwise contributing to the crowdsourcing idea. Alternatively, the crowdsourcing item may include a crowdfunding project, where contributions may include investments in a product or project until a funding goal is reached. Additionally, contributions may be received in exchange for one or more products or services to be produced or already produced as a pre-ordering or ordering.

Besides, contributions may be associated with partial investments to be invested in a startup, joint venture, or another company or project. The partial investments may be combined to reach an amount eligible for investment and invested as a common investment.

Furthermore, the crowdsourcing system may be used to receive support from funs and/or followers in social networks as a crowd social assistance. In this case, users may provide donations to the owner of a crowdsourcing item.

In some embodiments, the crowdsourcing may include receiving of a crowd opinion. Thus, the crowdsourcing item may be determined as a crowd voting item and votes may be received in support of a product, a service, or an idea associated with the crowd voting item.

In yet further embodiments, crowdsourcing item may include a crowd game, where the contributions may include game actions.

The information associated with the crowdsourcing items may be stored in the database 220 and may be accessible for users of the online community via a web-site, application, or newsletters associated with the crowdsourcing system 200.

The crowdsourcing system 200 may receive contributions from the users. After each contribution or after specific periods, the system 200 may calculate the total amount of the contributions. When the target of the crowdsourcing is reached, the contributions may be transferred to the owner.

Additionally, a maximum number of the contributions associated with one crowdsourcing item and/or owner may be determined to detect a maximum contribution item or owner. The maximum contribution owner may receive an award, for example, a monetary award, a title, a discount for the crowdsourcing system, and so forth.

The database may be configured to store the information related to crowdsourcing items and contributions associated with the items, owners of the items, and so forth.

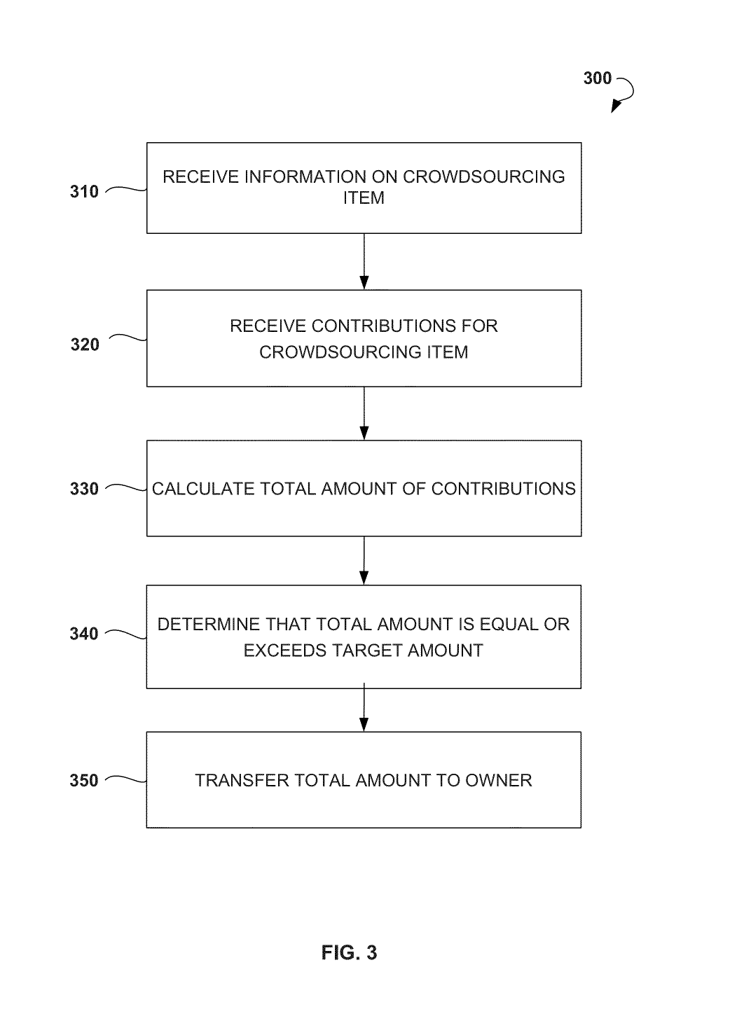

FIG. 3 is a flow chart illustrating a method 300 for crowdsourcing, in accordance with some example embodiments. The method 300 may be performed by logic that may comprise hardware (e.g., dedicated logic, programmable logic, and microcode), software (such as software run on a general-purpose computer system or a dedicated machine), or a combination of both. In one example embodiment, the processing logic resides at the crowdsourcing system 200, and the various elements of the system 200 can perform the method 300. It will be appreciated by one of ordinary skill that examples of the foregoing modules may be virtual, and instructions said to be executed by a module may, in fact, be retrieved and executed by software. Although various elements may be configured to perform some or all of the various operations described herein, fewer or more elements may be provided and still fall within the scope of various embodiments.

As shown in FIG. 3, the method 300 may commence at operation 310 with receiving information on a crowdsourcing item. The crowdsourcing item may include a product, a service, a content, an idea, and a business and may be associated with an owner of the item. The information may be received through a user interface of the crowdsourcing system 200 via network or otherwise. The received information may be available for online community through various means, including a web site associated with the crowdsourcing system 200, specific application, and the like.

At operation 320, one or more contributions for the crowdsourcing item may be received from one or more users being a part of the online community. The contributions include monetary, informational, collaborative, content amending or other contributions according to the type of the crowdsourcing item specified by the owner, and/or requested contribution type.

In some embodiments, when the owner specifies a target amount of the contributions, the crowdsourcing system 200 may calculate a total amount of the contributions at operation 330. When, at operation 340, the system 200 determines that the total amount of the contributions is equal or exceeds the target amount, the receipt of contributions may be stopped and the crowdsourcing item may be marked as successfully crowdsourced.

At operation 350, the crowdsourcing system 200 may transfer the total amount of the contributions to the owner. After the transfer is performed, the owner may deliver the crowdsourcing item to the contributed users. Each of the users may receive a portion of the crowdsourcing item proportional to a contribution associated with the user. Alternatively, the owner may produce the crowdsourcing item and then deliver a copy of the produced items to the users, make the crowdsourced item publicly available (e.g. if the crowdsourced item is an article, a musical track, a video, and so forth), and so forth. Alternatively, the user who made a contribution to the crowdsourcing item may receive a share of the item, a portion of income generated by the crowdsourcing item, and so forth.

In some cases, contributions to the crowdsourcing item may be associated with one or more awards. The awards may include a free copy of the item generated using the contributions, an acknowledgement to the contributed users, and so forth. In some embodiments, the award may be a result of the contributions, for example, a musical track recorded using the contributions.

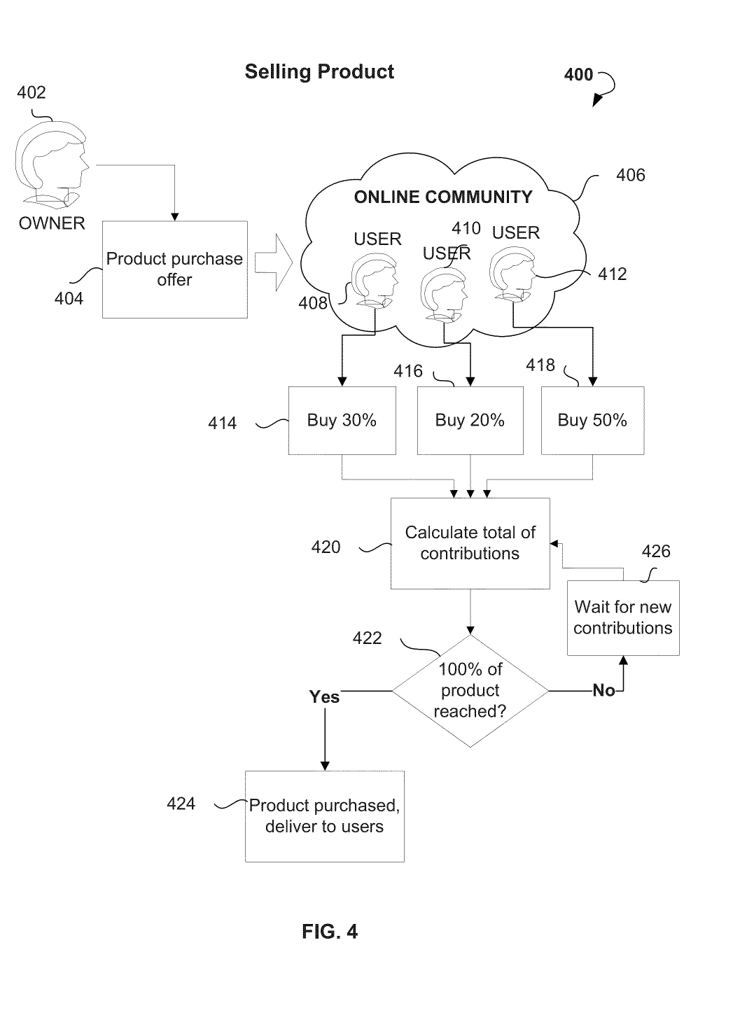

FIG. 4 shows an example crowdsourcing process associated with selling a product, in accordance with some embodiments. The example crowdsourcing process 400 may start with receiving a product purchase offer 404 from an individual or organization. The individual or organization may be considered an owner 402 of the product purchase offer 404.

The offer 404 may include a product description and a target amount of the contributions for product purchase. Thus the owner 402 may specify that a target amount he wants to receive for the product is, for example, USD 100. The offer 404 may be distributed online, for example, by placing it at a web site associated with the crowdsourcing system. Online community 406 may have access to the offer 404 via a network. One or more users constituting the online community 406 may provide contributions associated with the offer 404. For example, a user 408 may wish to buy 30% 414 of the product, a user 410—20% (416) of the product, while a user 412—50% (418) of the product. On receiving a contribution, a total of the contributions may be calculated 420 to determine whether the contributions cover 100% of the product 422. If the contributions cover the target amount associated with the product, the product may be considered purchased and delivered 424 to the users 408, 410, and 412 either proportionally to their contributions or otherwise. The contributions may be transferred to the owner 402. In some embodiments, a fee in consideration for crowdsourcing servicing may be deducted by the system.

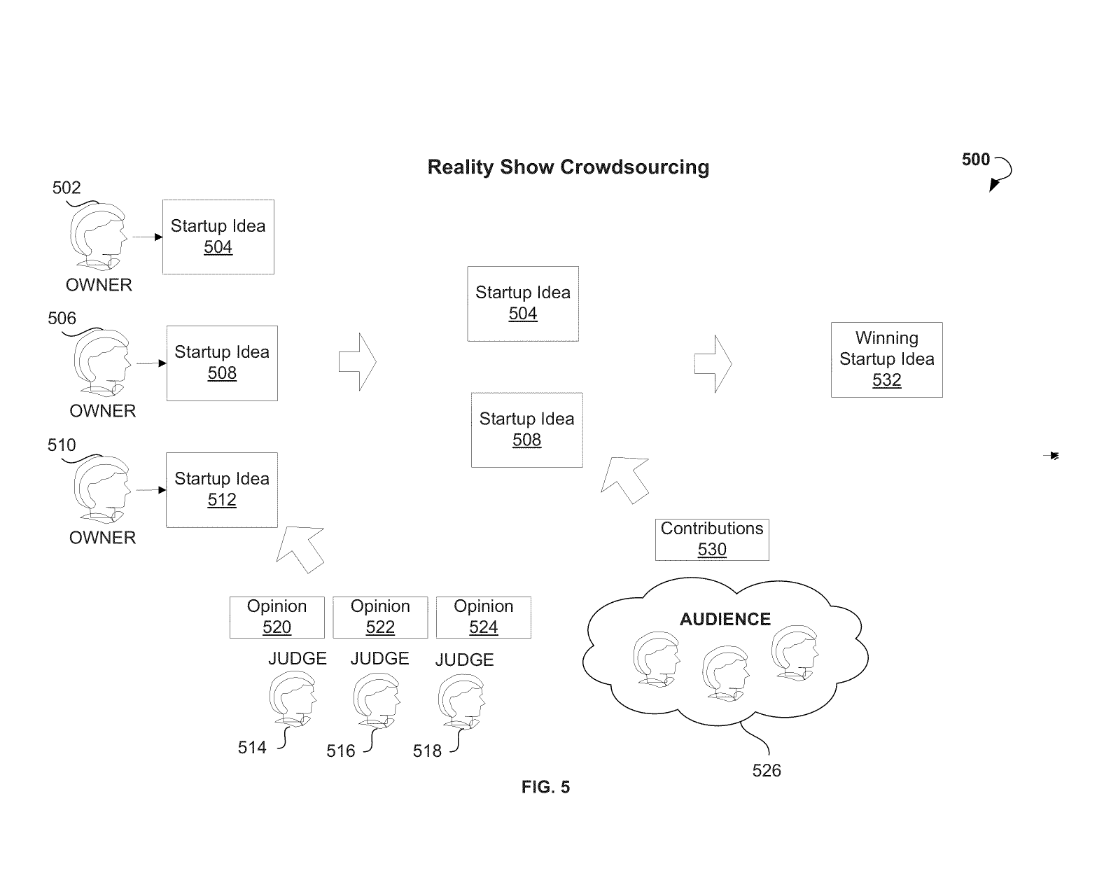

In one example embodiment, crowdsourcing may include a reality show crowdsourcing 500 as illustrated by FIG. 5. The reality show crowdsourcing 500 may be an interactive, competitive fundraising program where owners 502, 506, 510 of startup ideas 504, 508, 512 present their startup ideas 504, 508, 512. The owners 502, 506, 510 may include product manufacturers, product designers, service providers, a non-profit organization, and startups owners who have what they consider to be a viable and potentially profitable business idea, but who lack funding and direction.

The owners 502, 506, 510 may pitch their idea to the judges on the show and public investors. Before the show, the owners 502, 506, 510 may define a specific amount of money that they wish to get and/or a percentage in the business that the owner 502, 506, 510 is offering to sell to the investors.

The startup ideas 504, 508, 512 may compete with each other based on a number and/or amount of contributions 530 received from an audience 526. Information associated with the startup ideas 504, 508, 512, preselected by an organizer of the reality show crowdsourcing, may be provided to the audience 526 via television broadcasting, a public demonstration, a radio broadcasting, an online broadcasting, and so forth. For example, the startup ideas 504, 508, 512 may be presented via social networks (e.g. Facebook, Google+, and so forth), demonstrations of the startup ideas 504, 508, 512 may be posted on YouTube, product descriptions may be posted in online shops (e.g. Amazon, Ebay, Walmart, and so forth). The information may include a description of a startup idea, a target amount for funding the startup idea, and so forth. Each startup idea 504, 508, 512 may be associated with an owner 502, 508, 510 of the startup idea 504, 508, 512.

In some embodiments, the startup ideas 504, 508, 512 to be presented in the reality show for crowdsourcing may be preselected in initial auditions by an organizer and/or judges 514, 516, 518. The initial auditions may go through at least a few sets of cuts. The initial auditions may include a brief audition through a website or in various cities. Only a predetermined number of the startup ideas 504, 508, 512 may pass to take part in the reality show.

When the information on startup ideas 504, 508, 512 is provided, judges 514, 516, 518 may provide their opinion 520, 522, 524 associated with the startup ideas 504, 508, 512. The judges 514, 516, 518, which may be investors or experienced businessmen, criticize the startup ideas 504, 508, 512 and their presentations made by the owners 502, 508, 510. Additionally, the judges 514, 516, 518 may provide a pre-investment amount to one or more of the startup ideas 504, 508, 512 at own discretion.

In some embodiments, an initial stage of the reality show may include “blind auditions,” where the judges 514, 516, 518 may face away from the owners 502, 508, 510 making the presentation and towards the audience during the startups owner performances and demos. One of the judges 514, 516, 518 who is interested in the presentation presses his button, which turns their chair toward the startups owner and illuminates the bottom of the chair to read “I invest in you” and at the same time the investment amount and team name of the startup shows on the display of the back of the chair that is turned towards the audience which the startups owner cannot see.

At the conclusion of the demonstration of presentations, a startups owner either defaults to the only judge who turned around, or selects a judge if more than one judge expressed his interest in the idea. The judges 514, 516, 518 may guide the owners 502, 508, 510 through the show process, mentor, give advice and support.

In various stages of the reality show, the owners 502, 508, 510 may make presentations individually or in groups. The owners 502, 508, 510 may be assisted by one or more coaches. A number of judges 514, 516, 518 may be predefined (for example, 3 judges) and each judge 514, 516, 518 may provide his opinion 520, 522, 524 on each startup idea 504, 508, 512. Additionally, the judges 514, 516, 518 may provide a pre-investment amount to one or more of the startup ideas 514, 516, 518 which they consider appropriate.

Based on the opinion 520, 522, 524, some of the startup ideas 504, 508, 512 may be considered failed and drop out of the real show crowdsourcing. The rest of the startup ideas 504, 508, 512 may continue competition.

The reality show may include “battle rounds” where a judge or a coach pairs two of his owners together to make a common presentation and then chooses one team to advance in the competition. In some embodiments, coaches may be assisted by celebrity mentors such as fortune 500 CEO.

Additionally, the judges 514, 516, 518 may have an opportunity to select one or two failed ideas associated with another judge and return the idea to the reality show.

In some stages of the show, the fate of the startup ideas 514, 516, 518 may be decided by public vote, the amount of investment received, and/or the quantity of products sold. The audience 526 may make contributions 530 to the startup ideas 504, 508, 512 of their choice. Contributions 530 may be received via one or more of the following: an SMS service, an online transaction, a phone service, a social network, a banking operation, a barcode scanning from a mobile device of a person, and so forth.

In some embodiments, a toll-free telephone number for each of the owners 502, 508, 510 may be displayed on a screen during a television broadcast of the show or be included in a presentation shown on YouTube, social network, and so forth. Viewers may call or send a text message to their preferred contestant's telephone number and to pledge an invest amount or buy a product from the startup. Each call or text message or each purchase and each product may be registered as a credit for that owner. In some embodiments, the number of contributions from one person may be limited. For example, only up to 20 calls in support of the owner may be received from the same phone number, and so forth.

Received contributions 530 associated with a specific startup idea 504, 508, 512 may be provided to the owner associated with this startup idea. Receiving of the contributions 530 may be performed during a predefined period of time. The owners 502, 508, 510 may use the received contributions as they think proper and periodically provide a progress report associated with their startup idea.

The startup ideas 504, 508, 512 which received a smaller amount of the contributions 530 may be considered failed. In some embodiments, failed startup idea may be sold to public. The sale may include a direct sale, a sale via an auction, a delayed sale, a sale with payment by installments, and so forth.

In some embodiments, the reality show may generate income through sales of television advertisements, merchandise, concert tickets, additional sponsorship, and so forth. Sponsors may receive a variety of promotions of their products on the show such as product placement, adverts, product promotions integrated into the show, various promotional opportunities, and the like. For example, a logotype of one or more products associated with the sponsor may be displayed during the reality show on a table of the judges; the owners may be shown in premises including a logotype or one or more products associated with the sponsors.

In some embodiments, the contributions may include media votes, such as the votes provided by a media representative, a newspaper, a magazine, an online media resource, a television channel, or a radio channel.

Owners of the startup idea may implement the startup ideas using the pre-investment amount and/or the contributions. The results of the implementation may be periodically provided by the owner to the audience in a progress report associated with the startup idea.

In some embodiments, production offers for implementation of the startup ideas may be received from one or more manufacturers.

An amount of the contributions 530 associated with each startup idea 504, 508, 512 may be evaluated. The contribution amounts may be compared to determine the startup ideas 504, 508, 512 that attract the least amount of contributions 530. Such startup ideas may be considered failed and drop out of the reality show crowdsourcing. The drop out procedure may periodically repeat and, finally, a winning startup idea which received the highest amount of the contributions may be determined. This process may be limited in time, thus determining a winning startup idea 532 may be based on a month, season or year round time. The winning startup idea 532 may receive an award. The award may include a monetary amount, a prize, a title, and so forth.

The winner and/or other owners may be required to pass a predefined amount or a percentage of the crowdsourced amount or total investment amount received in the business ventures of the winner for the promotion, publicity and advertisement.

In some embodiments, third party advertisements may be displayed at various steps of the reality show crowdsourcing.

Furthermore, startups products and services may be displayed in a theme park to have show ticketing fee.

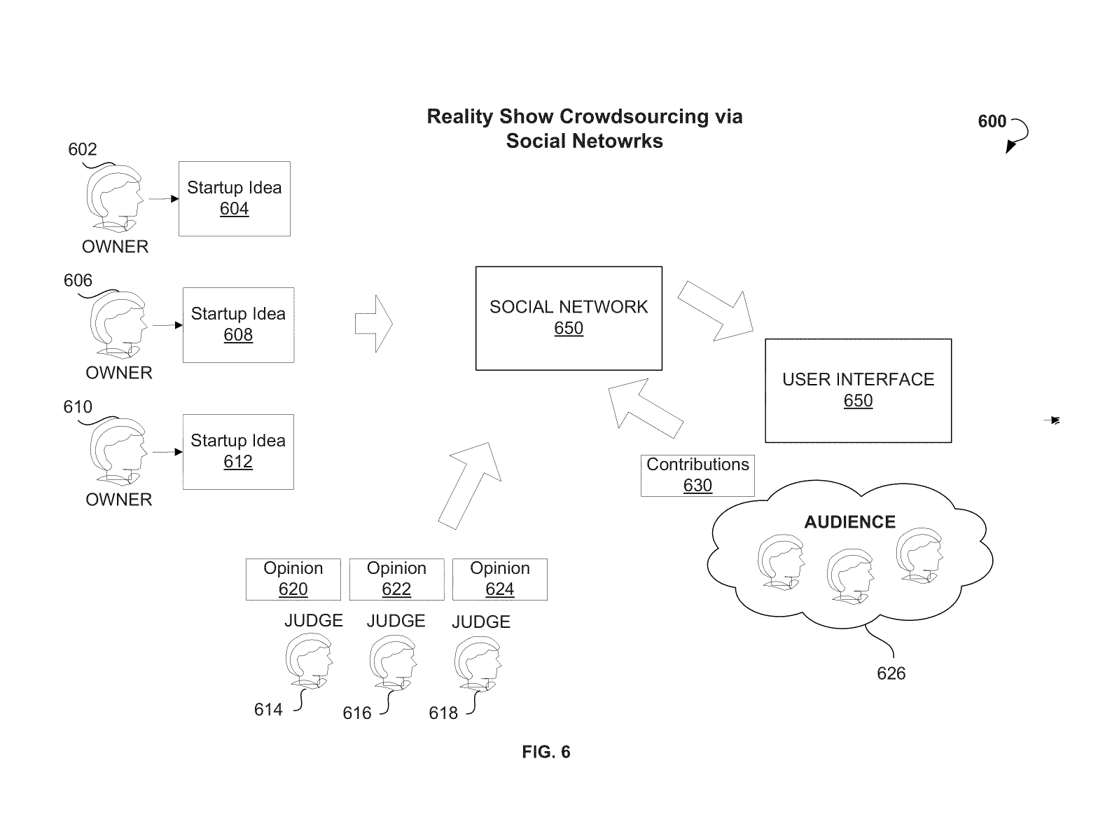

FIG. 6 illustrated reality show crowdsourcing via social networks 600. Startup ideas 604, 608, 612 associated with owners 602, 606, 610 may be presented via one or more social networks 650 through video, audio, photo, and/or text materials. Additionally, information about judges 614, 616, 618 and their opinions 620, 622, 624 associated with the startup ideas 604, 608, 612 may be also presented in the social network 650.

The audience 626 may access information on the startup ideas 604, 608, 612, judges 614, 616, 618, and their opinions 620, 622, 624 via a user interface 650 and provide their contributions 630 by voting in the social network 650 or otherwise.

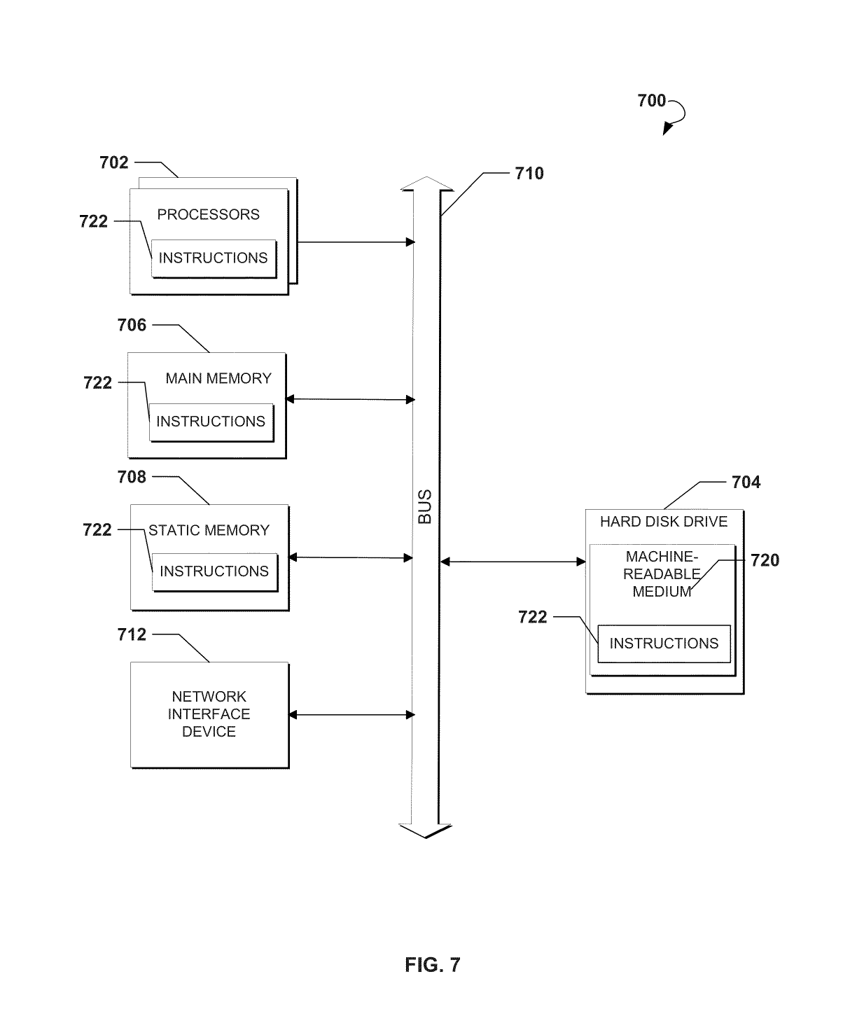

FIG. 7 shows a diagrammatic representation of a computing device for a machine in the exemplary electronic form of a computer system 700, within which a set of instructions for causing the machine to perform any one or more of the methodologies discussed herein can be executed. In various exemplary embodiments, the machine operates as a standalone device or can be connected (e.g., networked) to other machines. In a networked deployment, the machine can operate in the capacity of a server or a client machine in a server-client network environment, or as a peer machine in a peer-to-peer (or distributed) network environment. The machine can be a personal computer (PC), a tablet PC, a set-top box (STB), a cellular telephone, a digital camera, a portable music player (e.g., a portable hard drive audio device, such as an Moving Picture Experts Group Audio Layer 3 (MP3) player), a web appliance, a network router, a switch, a bridge, or any machine capable of executing a set of instructions (sequential or otherwise) that specify actions to be taken by that machine. Further, while only a single machine is illustrated, the term “machine” shall also be taken to include any collection of machines that individually or jointly execute a set (or multiple sets) of instructions to perform any one or more of the methodologies discussed herein.

The example computer system 700 includes a processor or multiple processors 702, a hard disk drive 704, a main memory 706 and a static memory 708, which communicate with each other via a bus 710. The computer system 700 may also include a network interface device 712. The hard disk drive 704 may include a computer-readable medium 720, which stores one or more sets of instructions 722 embodying or utilized by any one or more of the methodologies or functions described herein. The instructions 722 can also reside, completely or at least partially, within the main memory 706 and/or within the processors 702 during execution thereof by the computer system 700. The main memory 706 and the processors 702 also constitute machine-readable media.

While the computer-readable medium 720 is shown in an exemplary embodiment to be a single medium, the term “computer-readable medium” should be taken to include a single medium or multiple media (e.g., a centralized or distributed database, and/or associated caches and servers) that store the one or more sets of instructions. The term “computer-readable medium” shall also be taken to include any medium that is capable of storing, encoding, or carrying a set of instructions for execution by the machine and that causes the machine to perform any one or more of the methodologies of the present application, or that is capable of storing, encoding, or carrying data structures utilized by or associated with such a set of instructions. The term “computer-readable medium” shall accordingly be taken to include, but not be limited to, solid-state memories, optical and magnetic media. Such media can also include, without limitation, hard disks, floppy disks, NAND or NOR flash memory, digital video disks, RAM, ROM, and the like.

The exemplary embodiments described herein can be implemented in an operating environment comprising computer-executable instructions (e.g., software) installed on a computer, in hardware, or in a combination of software and hardware. The computer-executable instructions can be written in a computer programming language or can be embodied in firmware logic. If written in a programming language conforming to a recognized standard, such instructions can be executed on a variety of hardware platforms and for interfaces to a variety of operating systems. Although not limited thereto, computer software programs for implementing the present method can be written in any number of suitable programming languages such as, for example, C, C++, C# or other compilers, assemblers, interpreters or other computer languages or platforms.

Thus, various systems and methods for selling products and services via crowdsourcing have been described. Although embodiments have been described with reference to specific example embodiments, it will be evident that various modifications and changes may be made to these embodiments without departing from the broader spirit and scope of the system and method described herein. Accordingly, the specification and drawings are to be regarded in an illustrative rather than a restrictive sense.

What is claimed is:

1. A computer implemented method for crowdsourcing, the computer implemented method comprising:
receiving information associated with a crowdsourcing item, wherein the information includes a target amount for crowdsourcing, the crowdsourcing item being associated with an owner of the crowdsourcing item;
receiving, from one or more of users, one or more contributions associated with the crowdsourcing item;
calculating a total amount of the one or more of contributions;
determining that the total amount is equal to or exceeds the target amount;
transferring the total amount to the owner; and
delivering the crowdsourcing item to the one or more users, each of the one or more users receiving a portion of the crowdsourcing item proportional to a contribution associated with a user, wherein
the crowdsourcing item includes a product, a service, a content, an idea, and a business,
the information is provided by the owner,
the one or more contributions include one or more investments, one or more votes, one or more content amendments, and one or more idea proposals, and
each of the one or more users receives a share of the crowdsourcing item.

2. The computer implemented method of claim 1, further comprising providing one or more awards to the one or more users in consideration for the one or more contributions, wherein the one or more awards are associated with a result of the one or more contributions.

3. The computer implemented method of claim 1, wherein the owner produces the crowdsourcing item using the one or more contributions and each of the one or more users receives a copy of the crowdsourcing item produced using the one or more contributions.

4. The computer implemented method of claim 1, wherein each of the one or more users receives a share of the crowdsourcing item.

5. A crowdsourcing system comprising:
a processor configured to:
provide, via a user interface, information associated with a crowdsourcing item, wherein the crowdsourcing item is offered for crowdsourcing, crowdsourcing item being associated with an owner of the crowdsourcing item;
receive, from one or more users, one or more contributions associated with the crowdsourcing item;
calculate a total amount of the one or more contributions;
determine that the total amount is equal to or exceeds a target amount;
deliver the crowdsourcing item to the one or more users, each of the one or more users receiving a portion of the crowdsourcing item proportional to a contribution associated with a user;
receive the information associated with the crowdsourcing item from the owner; and
a database in communication with the processor, the processor being configured to store information associated with the crowdsourcing item, the target amount, and the one or more contributions, wherein the crowdsourcing item includes at least one of:
a crowdsourcing idea, wherein the one or more contributions include sharing, commenting, and improving of the crowdsourcing idea,
a crowdfunding project, wherein the one or more contributions include investments in a product or project until a funding goal is reached,
a crowd pre-ordering, the crowd pre-ordering including receiving the one or more contributions in exchange for one or more products to be produced, the one or more products associated with the crowd pre-ordering,
a crowd ordering, the crowd ordering including receiving the one or more contributions in exchange for one or more products associated with the crowd ordering,
a crowd equity, wherein the one or more contributions include partial investments to be invested in a startup, the investments being combined to form an investment,
a crowd social assistance, wherein the one or more users provide one or more donations to the owner,
a crowd voting item, wherein the one or more contributions include votes in support of a product, a service, or an idea associated with the crowd voting item, and
a crowd game, wherein the one or more contributions include game actions.

6. The crowdsourcing system of claim 5, wherein a maximum number of the one or more contributions associated with the owner is determined to detect a maximum contribution owner, the maximum contribution owner receiving an award, and the one or more contributions include one or more investments, one or more votes, one or more content amendments, and one or more idea proposals.

7. The crowdsourcing system of claim 5, wherein the processor is further configured to provide one or more awards to the one or more users in consideration for the one or more contributions, wherein the one or more awards are associated with a result of the one or more contributions and each of the one or more users receives a copy of the crowdsourcing item produced using the one or more contributions.

8. The crowdsourcing system of claim 5, wherein the owner produces the crowdsourcing item using the one or more contributions.

9. A computer implemented method for social network crowdsourcing and reality show crowdsourcing, the computer implemented method comprising:
providing information associated with a plurality of startup ideas, wherein the information includes a target amount for funding a startup idea, each of the plurality of startup ideas being associated with an owner of the startup idea;
receiving, from each of a predefined number of judges, an opinion associated with each of the plurality of startup ideas;
receiving, from an audience, a plurality of contributions associated with the plurality of startup ideas;
evaluating an amount of contributions associated with each of the plurality of startup ideas;
based on the evaluation, periodically selecting one or more failed startup ideas, the failed startup idea dropping out of the reality show crowdsourcing;
determining a winning startup idea, the winning startup idea receiving an award.

10. The method of claim 9, wherein the plurality of startup ideas is preselected by an organizer of the reality show crowdsourcing.

11. The method of claim 9, wherein each of the predefined number of judges provides a pre-investment amount to one or more of the plurality of startup ideas.

12. The method of claim 9, wherein the plurality of contributions associated with the startup idea are provided to the owner associated with the startup idea, the plurality of contributions is received via one or more of the following: an SMS service, an online transaction, a phone service, a banking operation, and by scanning a barcode associated with a startup idea.

13. The method of claim 9, wherein the receiving of the plurality of contributions includes receiving votes through one or more social network services and the plurality of contributions includes media votes, the media votes comprising votes provided by a media representative, a newspaper, a magazine, an online media resource, a television channel, or a radio channel.

14. The method of claim 9, wherein the owner at least one of periodically provides a progress report associated with the startup idea, acts individually or in a group with other owners in one or more rounds, is associated with a coach, the coach guiding the owner during a reality show, includes a product manufacturer, product designer, and service provider, specifies a target amount to finance a startup idea associated with the owner, and specifies a percentage to be provided to the judges in return to investments.

15. The method of claim 9, further comprising displaying a third party advertisement.

16. The method of claim 9, wherein the providing of the information associated with the plurality of startup ideas includes at least one of a television broadcasting, a public demonstration, a radio broadcasting, online broadcasting, presenting of the information via one or more social network services, presenting of the information via one or more web-sites, and the contributions being received via the one or more web-sites.

17. The method of claim 9, wherein the receiving of the plurality of contributions is performed during a predefined period of time.

18. The method of claim 9, wherein the failed startup idea is sold to public, the sale including a direct sale, a sale via an auction, a delayed sale, and a sale with payment by installments.

19. The method of claim 9, further comprising receiving production offers from one or more manufacturers, wherein the production offers are associated with the plurality of startup ideas.

20. The method of claim 9, further comprising presenting of data related to the judges, the amount of contributions, contributors, the one or more failed startup ideas, and the winning startup idea via one or more social network services.

21. The method of claim 9, wherein an income is generated through displaying a third party advertisement, selling of products associated with the plurality of startup, selling of tickets, receiving additional sponsorship.

22. The method of claim 9, further comprising receiving additional sponsorship for one or more sponsors, wherein, in exchange for the additional sponsorship, products associated with the one or more sponsors are promoted in a reality show and one or more advertisements associated with the one or more sponsors are displayed in the reality show.

23. The method of claim 9, wherein a logotype of one or more products associated with the one or more sponsors are displayed during the reality show on a table of a judge and wherein the owner is shown in premises including a logotype or one or more products associated with the one or more sponsors.

24. The method of claim 9, wherein plurality of products or services associated with the plurality of the startup ideas is displayed in a theme park.

25. The method of claim 9, wherein the determining a winning startup idea is based on a month, season or year round time and the award includes a monetary amount, a prize and a title.

26. The method of claim 9, wherein the predefined number of judges provides the opinion based on a blind audition, wherein the judges face away from the owner presenting a startup idea.

27. The method of claim 9, wherein the winner provides a predetermined amount or a percentage of the award.

28. The method of claim 9, wherein the startup idea includes fundraising associated with a non-profit organization.

29. The method of claim 9, wherein the audience makes the contributions though a mobile device, wherein the mobile device generates a payment barcode encoding payment information, the payment barcode being scannable by a barcode scanner.

30. A non-transitory computer-readable medium comprising instructions, which when executed by one or more processors, perform the following operations:
provide, via a user interface, information associated with a crowdsourcing item, wherein the crowdsourcing item is offered for crowdsourcing, crowdsourcing item being associated with an owner of the crowdsourcing item;
receive, from one or more users, one or more contributions associated with the crowdsourcing item;
calculate a total amount of the one or more contributions;
determine that the total amount is equal to or exceeds the target amount; and
store the information associated with a crowdsourcing item, the target amount, and the one or more contributions.
